(19) United States
(12) Patent Application Publication
(10) Pub. No.: US 2020/0409465 A1
(43) Pub. Date: Dec. 31, 2020

(54) APPARATUS FOR DETECTING GESTURES

(71) Applicant: Raymond Wai Hang CHU, Hong Kong (CN)

(72) Inventors: Raymond Wai Hang CHU, Hong Kong (CN); Alfred Sing Ping WONG, Hong Kong (CN)

(21) Appl. No.: 16/457,001

(22) Filed: Jun. 28, 2019

(51) Int. Cl. G06F 3/01; G01J 5/02

(52) U.S. Cl. CPC G06F 3/017; G01J 5/027

(57) ABSTRACT

An apparatus for detecting and recognizing a gesture provided by an object. The apparatus includes an infrared emitter for emitting infrared signals to be at least partially reflected by the object, an infrared detector for detecting intensity of the infrared signals reflected by the object moving along an axis, a processor associated with the infrared detector for quantizing the intensity of the infrared signals within a measurement cycle into a signal intensity profile, and an adjuster configured to restrict field of detection such that the signal intensity profiles resulting from the object moving along a first axis, or a second axis, perpendicular to the first axis, can be distinguished.

### FIELD OF THE INVENTION

The present invention relates to an apparatus for detecting a gesture performed by a user's hand, particularly, an apparatus for recognizing and distinguishing different gestures for controlling operations of an electric powered device.

### BACKGROUND OF THE INVENTION

Since the time that computers have become an indispensable part of our lives, the interactions between humans and machines have always been attempted to improve. Previously, the ways humans interacted with machines or devices relied on physical input means, for example, by means of physical buttons, switches or remote controllers. Over the years, attempts have been made to make human-computer interaction as natural and intuitive as possible. To at least partially fulfil these requirements, devices incorporating newer breed of input means such as the popular touch screen technology and voice recognition technology have emerged. However, the inherent limitations of these input means, for example, the need of a touch screen surface or the inaccuracy of voice commands recognition, hindered the user experiences of these devices. To overcome these limitations, devices with gesture controlled functionality have emerged. Typically, gestures detection essentially relies on a receiver, such as camera, ultrasonic and radar sensor to acquire data to be analyzed. However, using these types of sensor often involves complex algorithms and requires extensive processing power, which substantially increases production and operation costs. Therefore, it is desirable to provide a gesture detecting apparatus that is simple, efficient and capable of providing sufficient accuracy of recognizing and distinguishing a wide variety of gestures for controlling operations of an electric powered device.

### SUMMARY OF THE INVENTION

The present invention is directed to a gesture detecting apparatus which allows a user to operate an electric powered device, such as an electrical appliance, by using gestures. The gesture detecting apparatus recognizes and distinguishes various gestures performed by the user which trigger control commands to operate the device without the need of a remote control or physical buttons, knobs or switches, etc.

According to the present invention, there is provided an apparatus for detecting and recognizing a gesture provided by an object, comprising:
an infrared emitter for emitting infrared signals to be at least partially reflected by a said object;
an infrared receiver for detecting intensity of said infrared signals reflected by a said object moving along an axis, said infrared emitter and said infrared receiver generating a field of detection;
a processor associated with the infrared receiver for quantizing the intensity of said infrared signals within a measurement cycle into a signal intensity profile, said processor being adapted to determine, by using an algorithm, whether said signal intensity profile conforms to a predetermined gesture profile associated with a specific gesture, then to execute a command associated with said predetermined gesture profile in an event that said signal intensity profile conforms to the predetermined gesture profile, and
an adjusting means extending parallel to a distance between said infrared emitter and said infrared receiver, configured to restrict the field of detection such that a said object moving along a first axis, parallel to said adjusting means, generates a first said signal intensity profile distinguishable from a second said signal intensity profile resulting from a said object moving along a second axis, perpendicular to said first axis, within said field of detection.

In an embodiment, said field of detection is truncated, along at least one of said first axis or said second axis, by said adjusting means.

In an embodiment, said field of detection is asymmetrical along said second axis.

In a further embodiment, said adjusting means is configured to further alter said field of detection such that a said object moving along said second axis in a first direction generates a signal intensity profile distinguishable from a signal intensity profile resulting from the said moving object moving along said second axis in a second direction opposite to the first direction.

In an embodiment, said adjusting means comprises a pair of parallel walls, said infrared emitter and said infrared receiver positioned in between said parallel walls.

Preferably, said parallel walls have different heights.

In an embodiment, said adjusting means comprises a light guide positioned above said infrared emitter and said infrared receiver, said light guide comprises at least one pair of opposing non-reflective principal sides.

In an embodiment, a surface of said light guide facing said infrared emitter or said infrared receiver is angled such that the field of detection is skewed to one side.

Preferably, said light guide is positioned immediately above said infrared emitter and infrared receiver.

Alternatively, wherein said infrared emitter and said infrared receiver are provided in form of a transceiver.

Preferably, the apparatus further comprises a blockage isolating said receiver within said adjusting means for minimizing cross talking between said infrared emitter and said infrared receiver.

More preferably, said blockage has a lower height comparing to said adjusting means.

According to another aspect of the present invention, there is provided an apparatus for detecting and recognizing a gesture provided by an object, comprising:
infrared emitters, comprising at least a first infrared emitter and a second infrared emitter, for emitting infrared signals to be at least partially reflected by a said object;
an infrared receiver, positioned in between said first infrared emitter and said second infrared emitter, for detecting intensity of said infrared signals reflected by a said object moving along an axis, said infrared emitters and said infrared receiver generating a field of detection;
a processor for quantizing the intensity of said infrared signals within a measurement cycle into a signal intensity profile, said processor being adapted to determine, by using an algorithm, whether said signal intensity profile conforms to a predetermined gesture profile associated with a specific gesture, then to execute a command associated with said predetermined gesture profile in an event that said signal intensity profile conforms to the predetermined gesture profile, and
an adjusting means extending parallel to a distance between said infrared emitters, configured to restrict the field of detection such that a said object moving along a first axis, parallel to said adjusting means, a second axis, perpendicular to said first axis, or a third axis, perpendicular to said first axis and said second axis, thereby causing generation of respective signal intensity profiles distinguishable from each other.

In an embodiment, said field of detection is truncated, along at least one of said first axis or said second axis, by said adjusting means.

In an embodiment, said field of detection is asymmetrical along said second axis.

In an embodiment, said adjusting means is further configured to restrict said field of detection such that a said object moving along said second axis in a first direction generates a signal intensity profile distinguishable from a signal intensity profile resulted by the said moving object moving along said second axis in a second direction.

In an embodiment, said adjusting means comprises a pair of parallel walls, said first infrared emitter and said infrared receiver positioned in between said parallel walls.

Preferably, said parallel walls have different heights.

In an embodiment, said adjusting means comprises a light guide positioned above said infrared emitters and said infrared receiver, said light guide comprises at least one pair of opposing non-reflective principal sides.

In an embodiment, a surface of said light guide facing said infrared emitters or said infrared receiver is angled such that the field of detection is skewed to one side.

Preferably, said light guide is positioned immediately above said infrared emitters and infrared receiver.

In an embodiment, further comprising a blockage isolating said receiver within said adjusting means for minimizing cross talking between said infrared emitter and said infrared receiver.

Preferably, said blockage has a lower height comparing to said adjusting means.

### BRIEF DESCRIPTION OF DRAWINGS

The present invention will now be described more specifically by way of example only with reference to the accompanying drawings, in which:

FIG. 1 is a block diagram illustrating the operation flow of the gesture detecting apparatus according to the present invention.

FIG. 2a shows a basic arrangement of the gesture detecting apparatus according to an embodiment of the present invention.

FIG. 2b illustrates a lateral swiping gesture performed over the gesture detecting apparatus according to FIG. 2a.

FIG. 2c shows a line graph used to represent the signal intensity profile resulting from the lateral swiping gesture according to FIG. 2b.

FIG. 3a illustrates a descending gesture performed over the gesture detecting apparatus according to FIG. 2a.

FIG. 3b shows a line graph used to represent the signal intensity profile resulting from the descending gesture according to FIG. 3a.

FIG. 4a illustrates an ascending gesture performed over the gesture detecting apparatus according to FIG. 2a.

FIG. 4b shows a line graph used to represent the signal intensity profile resulting from the ascending gesture according to FIG. 4a.

FIG. 5a illustrates a tapping gesture performed over the gesture detecting apparatus according to FIG. 2a.

FIG. 5b shows a line graph used to represent the signal intensity profile resulting from the tapping gesture according to FIG. 5a.

FIG. 6a shows a gesture detecting apparatus according to another embodiment of the present invention, and illustrates a longitudinal swiping gesture being performed over the gesture detecting apparatus.

FIG. 6b shows a line graph used to represent the signal intensity profile resulting from the longitudinal swiping gesture according to FIG. 6a.

FIG. 6c shows a line graph used to represent the signal intensity profile resulting from the longitudinal swiping gesture performed in an opposition direction to that as illustrated in FIG. 6a.

FIG. 7a shows a gesture detecting apparatus according to FIG. 2a, fitted with an adjusting means.

FIG. 7b illustrates a narrowed field of detection generated by the gesture detecting apparatus according to FIG. 7a.

FIG. 8 shows a gesture detecting apparatus according to FIG. 6a, fitted with an adjusting means.

FIG. 9 shows a gesture detecting apparatus according to another embodiment of the present invention, having an adjusting means surrounding the infrared receiver.

FIG. 10a illustrates a right longitudinal swiping gesture being performed over the gesture detecting apparatus according to FIG. 8.

FIG. 10b shows a line graph used to represent the signal intensity profile resulting from the longitudinal swiping gesture according to FIG. 10a.

FIG. 11a illustrates a left longitudinal swiping gesture being performed over the gesture detecting apparatus according to FIG. 8.

FIG. 11b shows a line graph used to represent the signal intensity profile resulting from the left longitudinal swiping gesture according to FIG. 11a.

FIG. 12a illustrates a descending gesture performed over the gesture detecting apparatus according to FIG. 8.

FIG. 12b shows a line graph used to represent the signal intensity profile resulting from the descending gesture according to FIG. 12a.

FIG. 13a illustrates an ascending gesture performed over the gesture detecting apparatus according to FIG. 8.

FIG. 13b shows a line graph used to represent the signal intensity profile resulting from the ascending gesture according to FIG. 13a.

FIG. 14a illustrates an ascending gesture ending with stabilizing the user's hand at an ascended position, performed over the gesture detecting apparatus according to FIG. 8.

FIG. 14b shows a line graph used to represent the signal intensity profile resulting from the gesture according to FIG. 14a.

FIG. 15a illustrates a lateral swiping gesture performed over the gesture detecting apparatus according to FIG. 8.

FIG. 15b shows a line graph used to represent the signal intensity profile resulting from the left lateral swiping gesture according to FIG. 15a.

FIG. 16a illustrates two compound gestures performed over the gesture detecting apparatus according to a dual-emitter type gesture detecting apparatus without adjusting means.

FIG. 16b shows a comparison of two line graphs used to represent the signal intensity profiles resulting from the two compound gestures according to FIG. 16a.

FIG. 17a illustrates the two compound gestures performed over the gesture detecting apparatus according to FIG. 8, fitted with an adjusting means.

FIG. 17b shows a comparison of two line graphs used to represent the signal intensity profiles resulting from the two compound gestures according to FIG. 17a.

FIG. 18a shows the gesture detecting apparatus having adjusting means comprising two walls of different heights for generating an asymmetrical field of detection. The figure further illustrates lateral swiping gestures being performed over the gesture detecting apparatus in one direction and then in an opposing direction.

FIG. 18b shows a comparison of two line graphs used to represent the signal intensity profiles resulting from each of the lateral swiping gestures according to FIG. 18a.

FIG. 19 shows another embodiment of gesture detecting apparatus according to the present invention having a light guide as the adjusting means.

FIG. 20a illustrates how the light guide and the walls restrict the field of detection according to the gesture detecting apparatus in FIG. 19.

FIG. 20b illustrates the light guide having an angle bottom surface alters and restricts the field of detection.

FIG. 21a illustrates the gesture detecting apparatus being assembled with a periphery panel of an electric powered device.

FIG. 21b shows a cut-away view of the gesture detecting apparatus, with the light guide positioned immediately above the infrared emitters and receiver.

FIG. 22a shows another embodiment of gesture detecting apparatus according to the present invention, having two sets of transceivers each fitted with a set of parallel walls as adjusting means. The figure further illustrates a lateral swiping gesture being performed over the gesture detecting apparatus.

FIG. 22b shows a line graph used to represent the signal intensity profile resulting from the lateral swiping gesture according to FIG. 22a.

FIG. 23a shows another embodiment of gesture detecting apparatus according to the present invention, having two sets of transceivers, and a light guide with angled bottom surfaces, as adjusting means. The figure further illustrates a lateral swiping gesture being performed over the gesture detecting apparatus.

FIG. 23b shows a line graph used to represent the signal intensity profile resulting from the lateral swiping gesture according to FIG. 23a.

FIG. 24a shows another embodiment of gesture detecting apparatus according to the present invention, having two sets of transceivers, and a light guide fitted with a blockage, using as an adjusting means. The figure further illustrates a lateral swiping gesture being performed over the gesture detecting apparatus.

FIG. 24b shows a line graph used to represent the signal intensity profile resulting from the lateral swiping gesture according to FIG. 24a.

### DETAILED DESCRIPTION OF THE PREFERRED EMBODIMENTS

To make the objectives, features, and advantages of the present invention more comprehensible, preferred embodiments of the present invention are described in details below with reference to the accompanying drawings. It should be understood that the embodiments shown in the accompanying drawings are not intended to limit the scope of the present invention, but are merely intended to be used for describing the essence and spirit of the technical solutions of the present invention.

The present invention relates a gesture detecting apparatus incorporating at least one proximity sensor device capable of providing digital output for determining the presence and movements of an object within a field of detection. Previous generation of proximity sensors typically provide only binary signals, i.e., on state and off state. State of the art proximity sensors combine optical and solid state technologies with built-in analog to digital converter (ADC), and is often integrated with a signal processor and a communication bus. Technically, a proximity sensor, such as infrared sensor, is able to determine not only presence of an object within the field of detection, and also the approximate distance between an object and the sensor, based on the principle that distance is inversely proportional to the signal intensity of the infrared signals reflected from the object. In other words, the closer the object located from the infrared sensor, the higher the infrared signal intensity will be detected, and vice versa.

The detection of a gesture performed by a user generally involves the preparation of data acquired by the infrared sensor, and the interpretation of these data by a gesture recognition algorithm. Once data is acquired as a result of a gesture performed over the infrared sensor, the recognition of the gesture as performed will then be carried out by built-in software using an algorithm that compares the acquired data with a collection of predetermine data sets indicative of various different predefined gestures. The algorithm determines whether the detected gesture corresponds to one of the predefined gestures, or is not recognized. In an event that the detected gesture is recognized by the algorithm, an associated command will be triggered by the processor, instructing the electric powered device to carry out a certain predefined function.

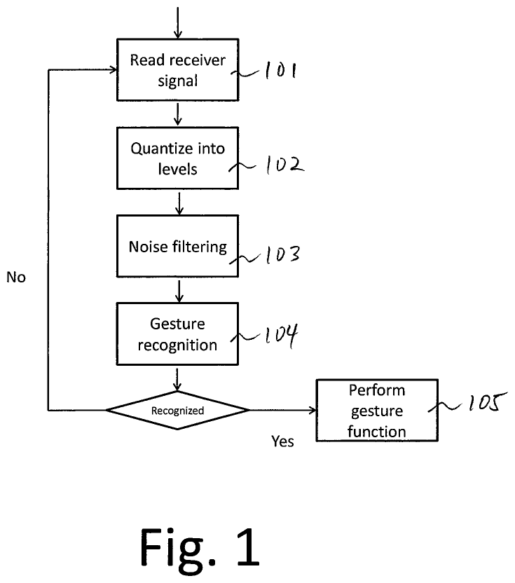

According to step 101 in FIG. 1, the receiver reads the intensity of infrared signal emitted by the infrared emitters in multiple instances per second. In step 102, the processor quantizes the change in signal intensity over a measurement cycle time period, forming a data set indicative of the gesture performed by the user. The data set may be acquired in a data stream within a measurement cycle of i.e., 2000 ms. Advantageously, noise filtering techniques may be employed by the processor to filter out signal noise, as indicated by step 103. Typically, digital filters such as finite impulse response filter (FIR) or low pass filter, implemented by software, can be used to achieve noise filtering.

The gesture detecting apparatus may incorporate multiple infrared emitters. The data used for gesture recognition is acquired in separate data streams or channels for each of the infrared emitters, i.e., one stream or channel is assigned for each emitter. This allows the gesture detecting apparatus to recognize and distinguish between directional swiping gestures.

In step 104, recognition of a gesture is accomplished by analyzing the intensity pattern generated by infrared signals reflected from an object, i.e., a user's hand. In order to differentiate between the signals emitted by either of the emitters, the emitters and receiver are multiplexed, in which they operate in pulsations one after another in quick successions. The infrared signal is then read out between each pulse by the infrared receiver and data are sent to the processor via a communication bus. For instance, when the hand is in the center of the field of detection, it reflects more infrared signals, i.e., higher signal intensity, from the emitter it is directly located above. If the hand is then moved across the field of detection, the signal from one emitter will increase before the other. This time variance of signal intensity in within the measurement cycle is analyzed by the algorithm to determine if a swipe gesture was made and in a particular direction.

On the receiver side, detection of signals emitted by each of the emitters occurs one after another in multiple detection cycles within the time period. Detection and logging of the signal intensity of each stream are performed in alternating successions within the measurement cycle, which forms a signal intensity profile for each of the streams.

According to the algorithm used in an embodiment of the present invention, each data set is indicative of a detected gesture performed by the user and is analyzed for two parameters: the standard deviation of signal intensities and the time delay between signal pulses. By comparing the results of the analysis to user-defined thresholds, the algorithm can recognize and distinguish the detected gesture.

The standard deviation is a measure of the spread of the data within the frame being analyzed, which is calculated using the following formula:

$$s = \sqrt{\frac{\sum {( x - \overline{x} )}^{2}}{n - 1}}$$

Where x is the mean of the current frame and n is the amount of samples being analyzed, i.e. frame length. A low standard deviation implies there is no change in the signal and there is either no hand in the field of detection or the hand is being held steady over the sensor and no swipe gesture is being made. A high standard deviation implies a large change in the signal, suggesting the movement of the hand across or towards the sensor. The detection algorithm only analyzes the frame for further parameters, if the signal is above a set standard deviation threshold. Generally, the presence of a sufficient time delay between the signals signifies that a swiping gesture has been made.

The algorithm then determines whether or not the performed gesture corresponds to one of the predefined gestures. In an event that the performed gesture is recognized by the algorithm, a corresponding command will be triggered by the processor, in step 105, instructing the electric powered device to carry out a certain predefined function. In the event that the performed gesture does not correspond to any of the predefined gestures, the gesture detection apparatus will return to step 101, and continue to detect for infrared signals received by the receiver and analyze the data for a possible match with any one of the predefined gestures.

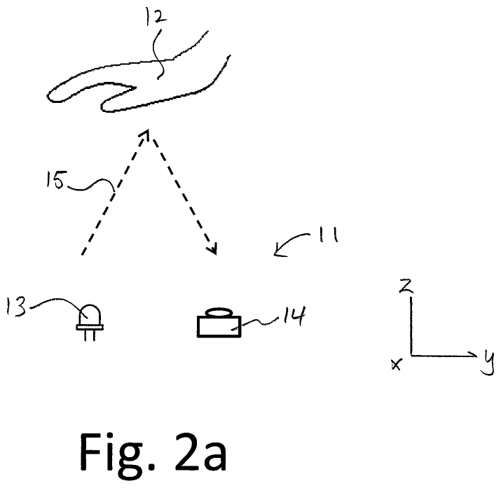

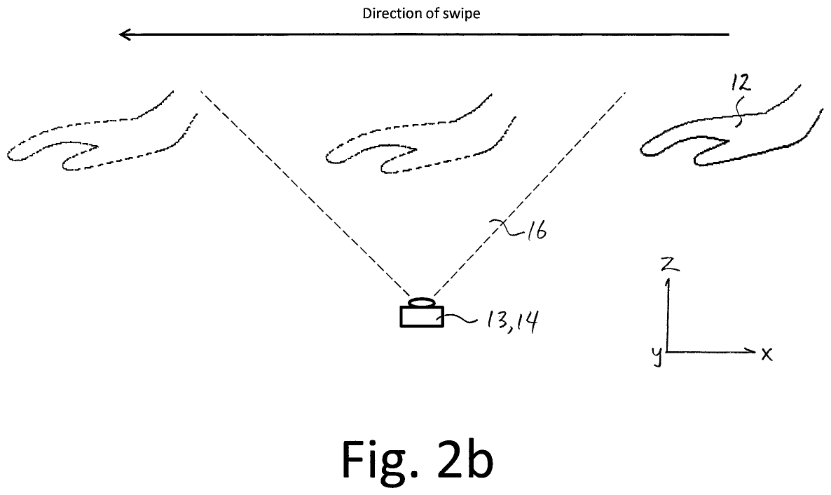

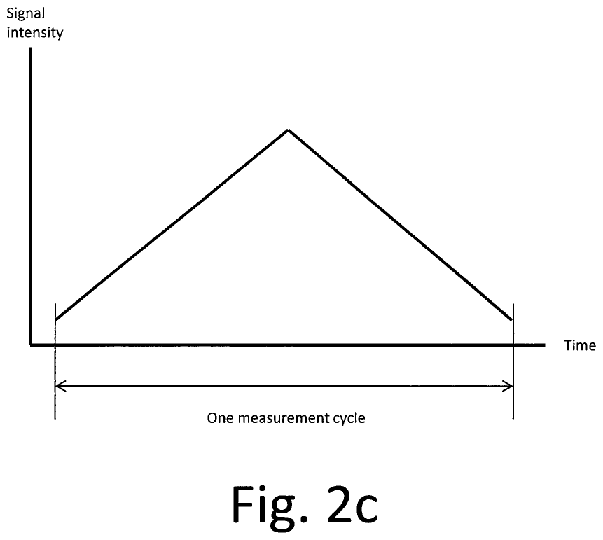

FIG. 2a illustrates an example of a basic arrangement of a gesture detection apparatus 11 according to an embodiment of the present invention. Specifically, an infrared emitter 13 and a receiver 14 are provided side by side along the Y-axis as shown, configured for detecting infrared signals reflected off from a moving or still object 12, such as a hand of a user. Alternatively, the infrared emitter 13 and receiver 14 may be provided as an infrared transceiver integrated with emitter and receiver. Typically, the infrared emitted by the infrared emitter 13 has a wavelength ranges from 850 nm to 2000 nm. The infrared emitter 13 and receiver 14 are arranged such that the directions of emission and reception are substantially parallel and, in the present case, are upward facing. The infrared receiver 14 is located at a distance away from the infrared emitter 13 in order to minimize signal cross-talking.

During operation of the gesture detecting apparatus 11, the infrared emitter 3 emits infrared signals 15 upwardly, defining a field of detection with the infrared receiver 14. According to FIG. 2b in which the gesture detecting apparatus is viewed normal to the Y-axis, the field of detection 16 has a generally fan shape detection range where objects located outside the field of detection 16 will not be detected by the gesture detecting apparatus 11. In the arrangement as shown, infrared emitted from the infrared emitter 13 interferes with the user's hand 12 within the field of detection 16 and reflects off the user's hand 12. The reflected infrared signal is then picked up by the infrared receiver 14. Accordingly, the intensity of the reflected infrared signal is registered by a built-in processor. Based on detecting the presence of the reflected infrared signal and the change of its signal intensity within a measurement cycle, i.e., a certain time period, motion generated by the user's hand 12 moving across the field of detection 16 can be detected.

FIG. 2b further illustrates an example of a basic horizontal swiping gesture performed by a user's hand 12 which can be recognized by the gesture detecting apparatus 11. Such swiping gesture requires the user's hand 12 swiping horizontally across the field of detection 16, along the X-axis. Specifically, the movement of the user's hand 12 across the field of detection 16 would produce a change of signal intensity detected by the infrared receiver 14. Such change of signal intensity over a measurement cycle, i.e., 2 secs, is then quantized into a data set which can be represented by a signal intensity profile in form of a line graph as shown by FIG. 2c.

According to FIG. 2c, the user's hand 12, initially located outside of the field of detection 16, causes minimal or no infrared signal detected at the beginning of the measurement cycle. As the user's hand 12 moves into the field of detection 16 and toward its center region, the detected signal intensity gradually increases to a maximum value, and then gradually decreases as the user's hand 12 moves past the center region and then leaves the field of detection 16, at where the reading of signal intensity return to minimum. Accordingly, the signal intensity profile of the swiping gesture as described would generally appear as an upward slope followed by downward slope, as shown by the line graph.

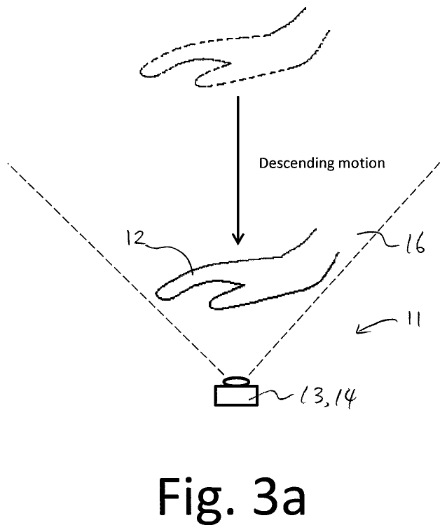

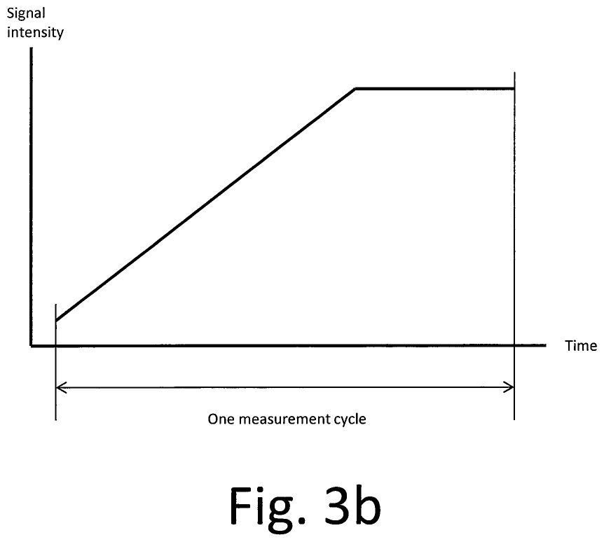

FIG. 3a and FIG. 3b illustrate another example of basic gesture, i.e., a vertical descending gesture. This gesture requires descending the user's hand 12 toward the gesture detecting apparatus 11, while maintaining the user's hand 12 within the field of detection 16. Initially, the user's hand 12 is held vertically above the gesture detecting apparatus 11 as shown, preferably, at a preferred distance of about 30 cm. As the hand 12 descends toward the receiver 14, the intensity of the reflected infrared signal would increase. Preferably, maintaining the user's hand 12 at a descended position would cause the infrared signal intensity to stabilize. The reading of a stabilized signal intensity reading may be used to signify that the vertical descending gesture is completed. Generally, the signal intensity profile of the vertical descending gesture can be represented by a line graph showing a rising slope followed by a plateau, as illustrated in FIG. 3b.

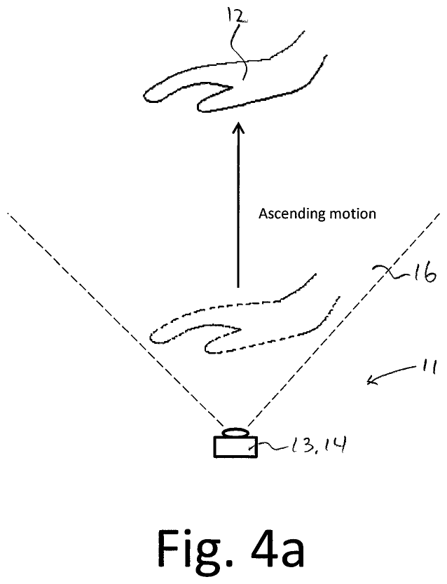

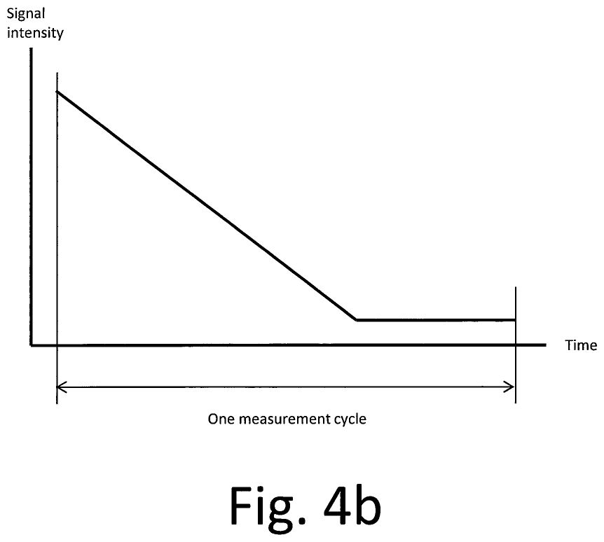

FIG. 4a illustrates a vertical ascending gesture which requires the user's hand 12 to begin at the descended position, followed by ascending vertically upward. As the user's hand 12 ascends upward, the intensity of infrared signal detected by the receiver would gradually decrease. Likewise, maintaining the hand 12 at an ascended position causes the intensity of the infrared signal to stabilize. The stabilized signal may be used to signify the completion of a vertical ascending gesture. Accordingly, the signal intensity profile of the vertical ascending gesture would generally appear as a falling slope followed by a flat line, as illustrated in the line graph in FIG. 4b.

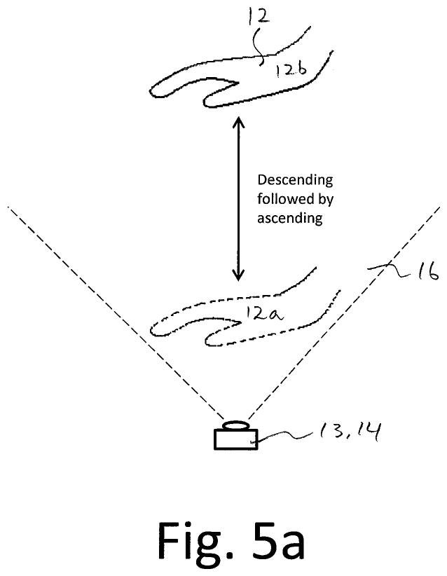

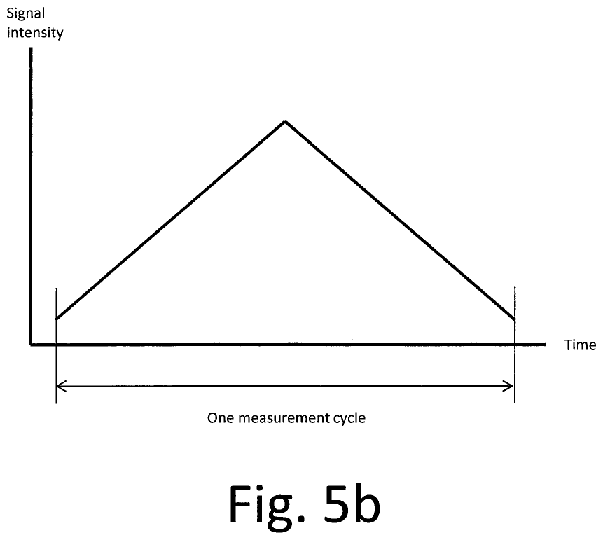

FIG. 5a illustrates the combining of the vertical descending gesture and the vertical ascending gesture. The combination of the vertical ascending and descending gestures essentially mimics the “tapping” of a button. Hence, this gesture can also be referred as a tapping gesture. The tapping gesture essentially requires the user to descend the hand 12 vertically to the descended position 12a, indicated by dash line, and ascending the hand back to its original position 12b, indicated by solid line. The signal intensity profile resulting from this compound gesture can be represented by a line graph appearing as an upward slope followed by a downward slope, as indicated in FIG. 5b.

As noted in FIG. 5b, the tapping gesture would generally produce a signal intensity profile resembling that of the lateral swiping gesture as previously illustrated in FIG. 2b which also comprises an upward slope and a downward slope. As such, there may be chances that a lateral swiping gesture and a tapping gesture may not be accurately distinguished by the gesture detecting apparatus 11.

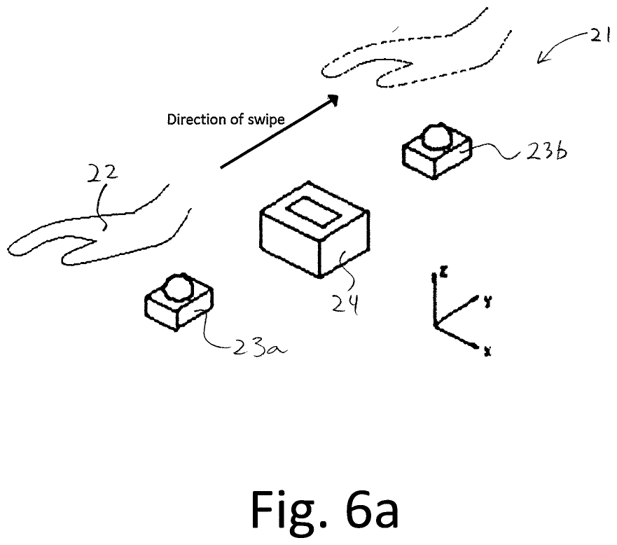

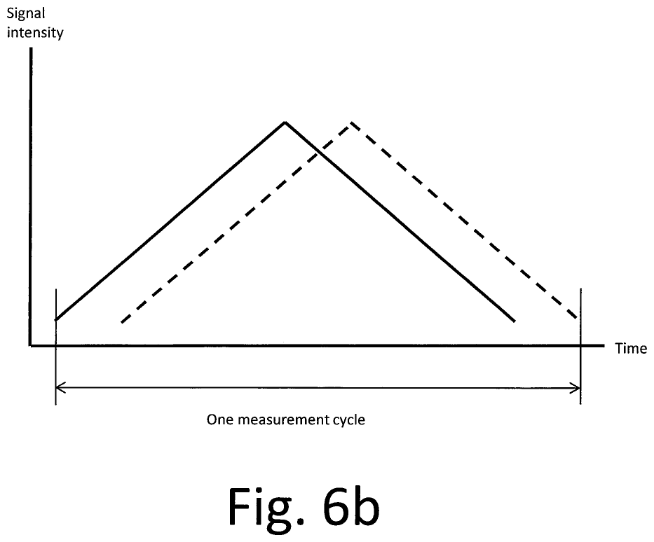

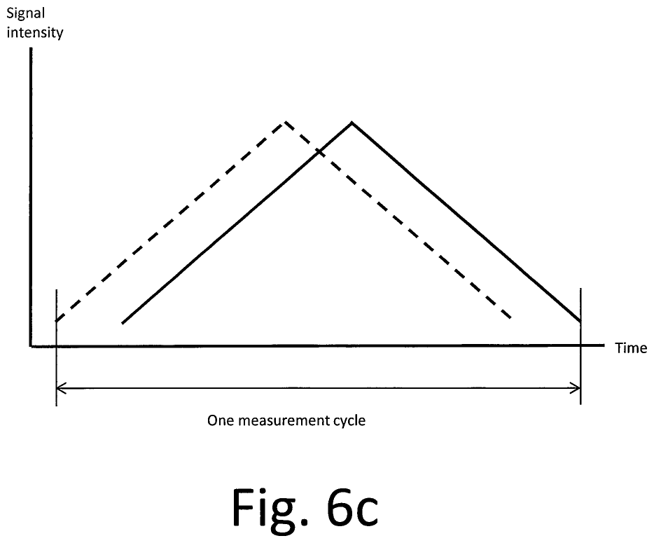

FIG. 6a illustrates another embodiment according to the present invention, directing to a dual-emitter type gesture detecting apparatus 21 including two infrared emitters, namely, a first emitter 23a and a second emitter 23b. An infrared receiver 24 is positioned in between the two infrared emitters 23a, 23b. Each of the infrared emitters 23a, 23b is configured to emit infrared signal one at a time rather than sending infrared simultaneously. The infrared signals are multiplexed signals, so that each of the infrared emitters 23a, 23b produces its own signal intensity profile within the measurement cycle, i.e., 5 ms. Multiplexed signals enable the algorithm to distinguish infrared signals emitted by each of the infrared emitters 23a, 23b.

The two infrared emitters 23a, 23b may be located away from the infrared receiver 24 by a certain distance to minimize cross-talking as much as possible. As shown, the infrared emitters 23a, 23b and the infrared receiver 24 are arranged longitudinally along Y-axis. The use of two infrared emitters can provide the gesture detecting apparatus 21 additional parameters for distinguishing between directional swiping gestures, such as a left swiping gesture and a right swiping gesture performed by the user's hand 22 along the Y-axis.

For instance, to perform a right swiping gesture recognizable by the algorithm, the user is required to swipe the hand 22 from the left side to the right side of the gesture detecting apparatus 21, along the Y-axis. Accordingly, the infrared receiver 24 would first receive infrared signal emitted by the left emitter 23a, followed by infrared signal emitted by the right emitter 23b. The resulted sequence of detected infrared signals would indicate a time shift in receiving of the two infrared signals within the multiplexed measurement cycle. Therefore, the reflected infrared signals as a result of each of the infrared emitters 23a, 23b would produce two data sets generating two partially overlapping signal intensity profiles which can be represented by the line graph as shown in FIG. 6b. The signal intensity profile generated by the left infrared emitter 23a is indicated by solid line, while the signal intensity profile generated by the right infrared emitted 23b is indicated by dash line. Likewise, a left swiping gesture along the Y-axis would generate two signal intensity profiles in a reversed sequence, as shown in the line graph of FIG. 6c. Accordingly, swiping motions in a specific direction along the Y-axis can be recognized and distinguished by the algorithm.

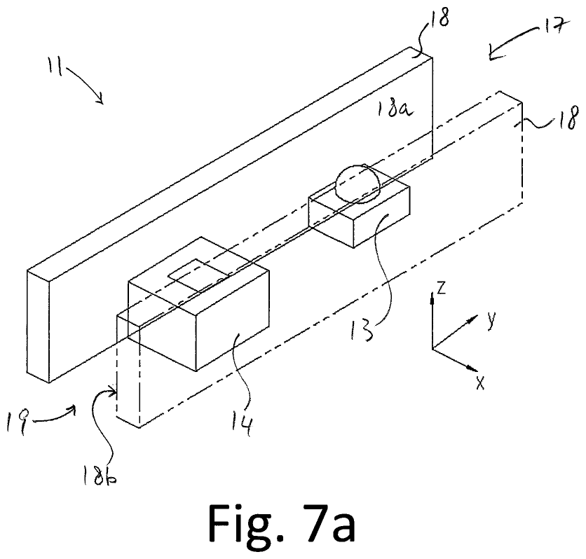

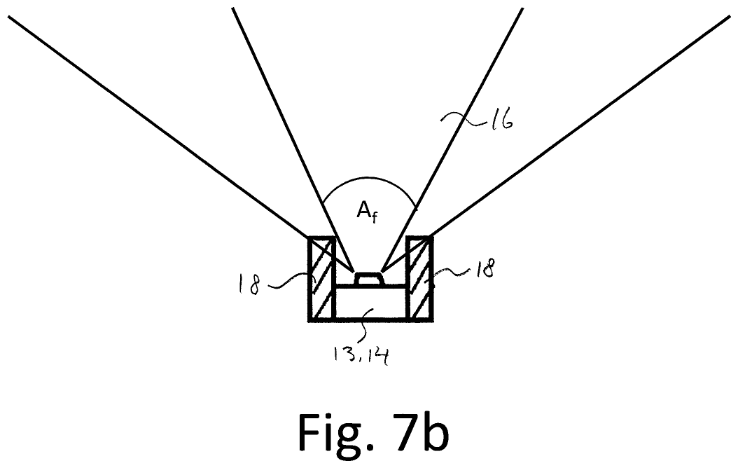

According to an embodiment as shown in FIG. 7a and FIG. 7b, an adjusting means 17, in form of barriers or walls, may be provided adjacent the infrared emitter 13 and the receiver 14 for changing the characteristics of the field of detection 16, such as narrowing or truncating the field of detection 16. The adjusting means 17 is a pair of parallel vertical walls 18 extends longitudinally parallel to the distance between the infrared emitter 13 and the infrared receiver 14 as shown. The parallel walls 18 form a channel 19 therebetween. Infrared emitter 13 and the infrared receiver 14 are located within the channel 19. In particular, inner sides of the walls 18a, 18b are preferably non-reflective, producing minimal to no internal reflection within the channel 19. The adjusting means 17 serves to limit, particularly, narrow the field of detection 16 along the X-axis to an angle A_{f}, of preferably, about 40 degrees. However, the field of detection 16 along the Y-axis is not affected or unchanged by the adjusting means 17. Preferably, the field of detection 16 along the X-axis may be restricted to a field angle of about 40 degrees, which can be achieved by using walls 18 of a suitable height, as shown in FIG. 7b.

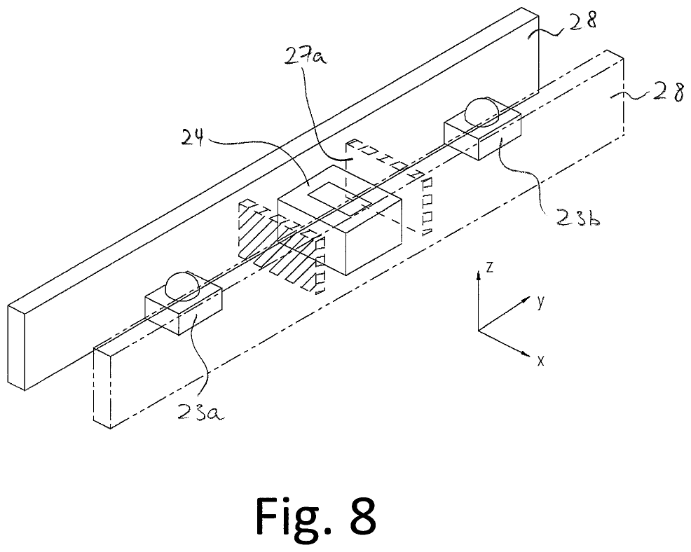

FIG. 8 illustrates the dual-emitter type gesture detecting apparatus 21 provided with an adjusting means 27. The adjusting means 27 is a pair of elongated parallel walls 28 which extend along and beyond the distance between the two infrared emitters 23a, 23b. The walls 28 should be of a certain height so that they can effectively block a portion of the infrared signal emitted by the emitter 23a, 23b, hence produces a narrowing effect of the field of detection 26. Optionally, an additional adjusting means 27a, also in form of a set of parallel walls, may be provided for only the infrared receiver 24, perpendicular to the walls 28, as shown. Preferably, the additional adjusting means 27a would have a lower height comparing to the walls 28. Advantageously, the additional walls 27a serves to minimize signal cross-talking between the infrared emitters 23a, 23b and the receiver 24, while also preventing the receiver 24 from receiving infrared signals other than those reflected off by the user's hand 22, reducing signal noise and thus improving the accuracy of gesture detection.

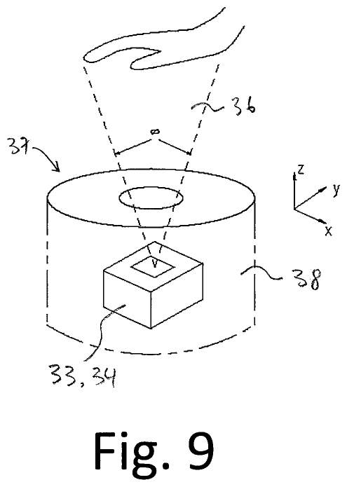

The adjusting means 37 may be a cylindrical wall 38 surrounding the receiver 34 as shown in FIG. 9. The cylindrical wall 38 has an effect of restricting the field of detection 36 to a narrowed field angle A_{F} in an all-direction manner rather than only along a single axis.

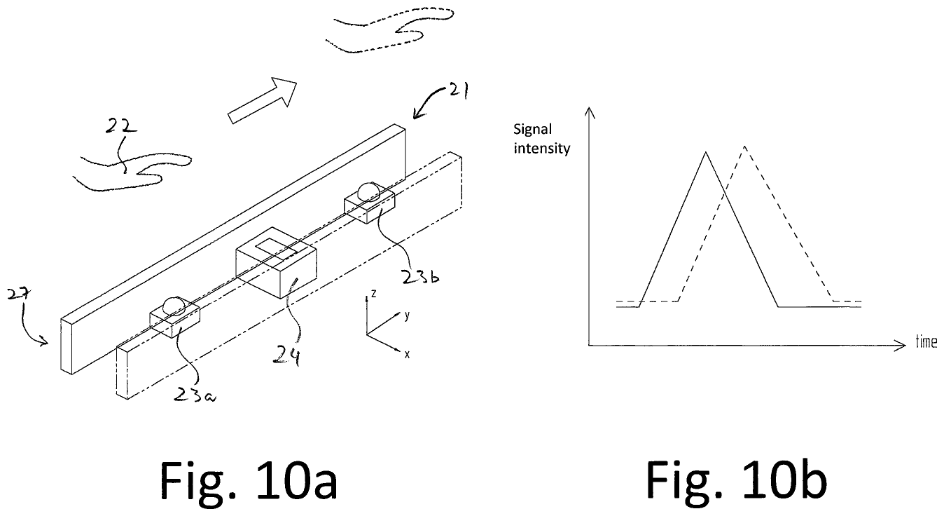

FIG. 10a to FIG. 17b illustrate various exemplary gestures that can be effectively recognized and distinguished by the gesture detecting apparatus 21 according to an embodiment of the present invention as illustrated in FIG. 8.

FIG. 10a shows a longitudinal swiping gesture performing by a user's hand 22. This swiping gesture requires the user's hand 22 to move along the adjusting means 27 from the left side to the right side. The gesture would generate a signal intensity profile which can be represented by the two sets of upward-downward slopes as shown in FIG. 10b. Specifically, the longitudinal swiping gesture generates a signal intensity profile containing two sets of upward-downward slope which are slightly offset with respect to each other. Such an offset is caused by the time delay which the infrared receiver 24 first receives the infrared signal emitted by the left infrared emitter 23a, followed by the infrared signal emitted by the right infrared emitter 23b. In this particular arrangement, the field of detection along the Y-axis is not restricted or controlled. Therefore, the signal intensity profile of a longitudinal swiping gesture along the Y-axis would correspond to that resulted from a same longitudinal swiping gesture performed over the gesture detecting apparatus without any adjusting means, such as that illustrated by FIG. 6a.

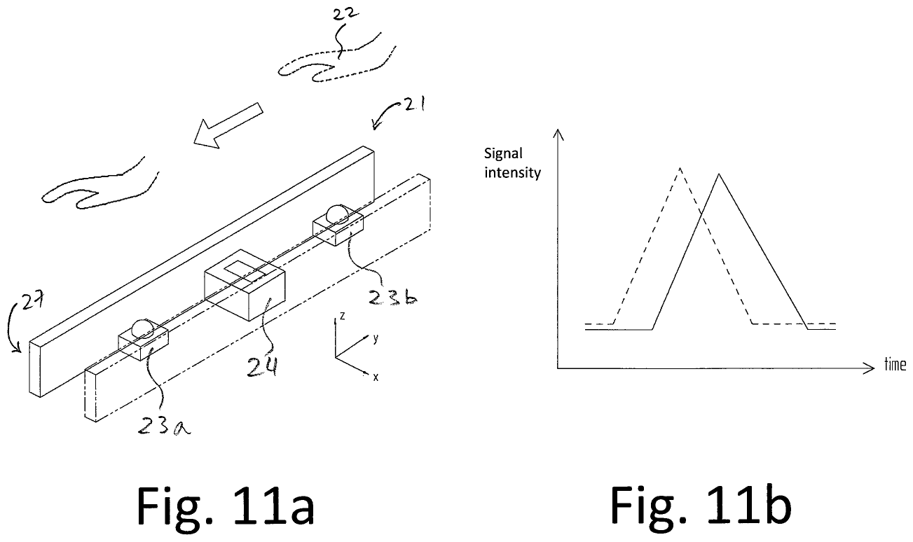

FIG. 11a illustrates a longitudinal swiping gesture performed in an opposite direction, i.e., toward the left side. Accordingly, the sequence of the detected infrared signal intensities would be reversed. The signal intensity profile generated by this left longitudinal swiping gesture can be represented by a graph containing two sets of upward-downward slope offset with respect to each other, but in a reversed sequence, as shown in FIG. 11b.

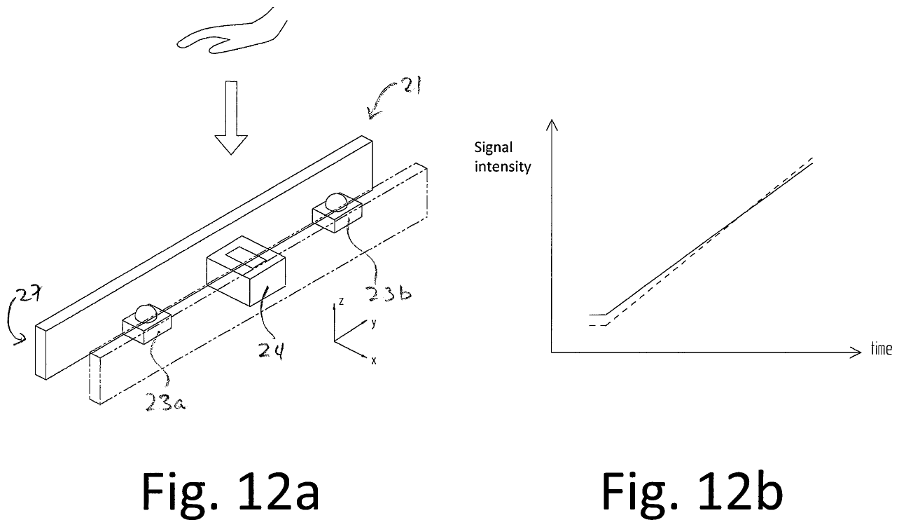

FIG. 12a depicts a vertical descending gesture along the Z-axis, which requires the user's hand maintained within the field of detection 26, for best accuracy. As shown in FIG. 12a, starting with the hand positioned at a distance above the receiver 24 and where the detected signal intensity is at a minimum, the hand 22 gradually descends the hand 22 downward and toward the infrared receiver 24. Such movement causes the detected signal intensity to gradually increase within the measurement cycle, and to generate a signal intensity profile which can be represented by a graph containing two substantially overlapped upward slopes, as shown in FIG. 12b.

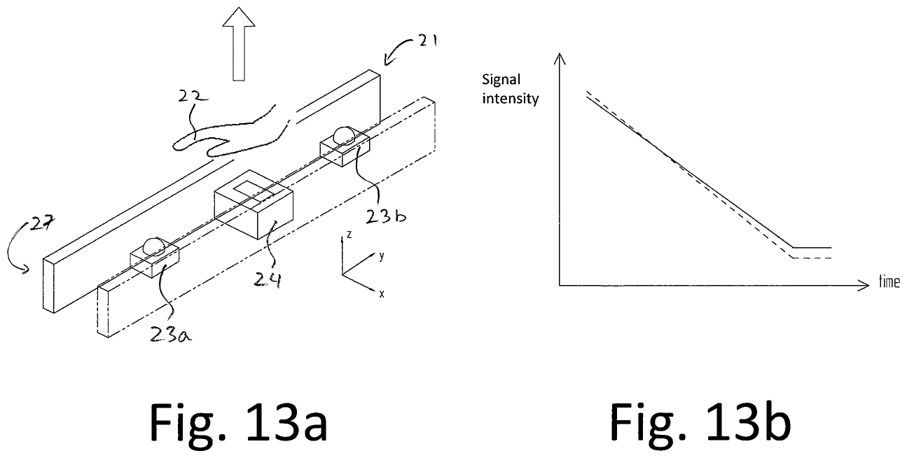

FIG. 13a illustrates a vertical ascending gesture along the Z-axis, which also requires the user's hand maintained within the field of detection 26. Starting in a position close above the infrared receiver 24, as shown in FIG. 13a, where the detected infrared signal intensity is high, the hand 22 gradually ascends upward and away from the infrared receiver 24. The ascending motion of the hand 22 causes the detected signal intensity to gradually decrease over the measurement cycle. The vertical ascending gesture would generate a signal intensity profile which can be represented by a graph containing two substantially overlapped downward slopes, as shown in FIG. 13b.

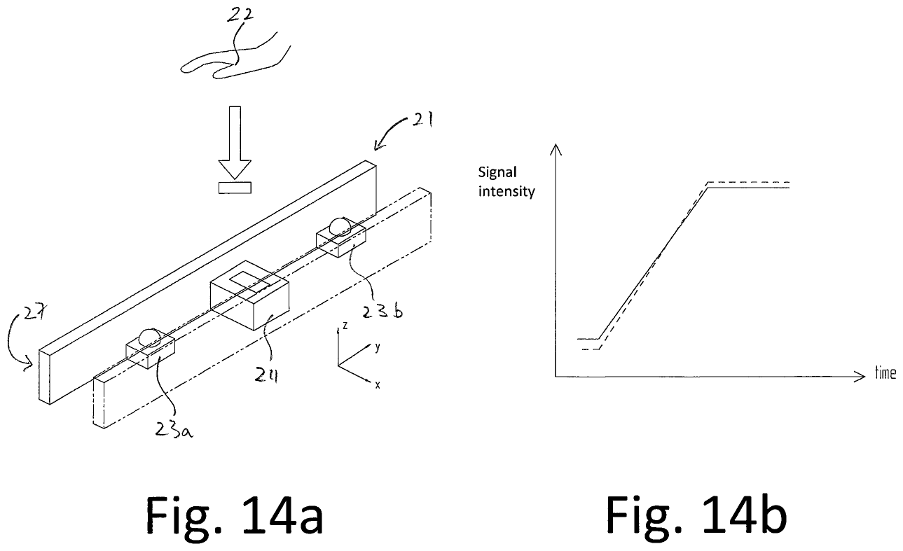

FIG. 14a illustrates a descending gesture similar to that illustrated by FIGS. 12a and 12b, only that the user's hand 22 remains still after the it has been descended to its lowest point. The detected infrared intensity would increase as the user's hand 22 descends, and stabilizes when the user's hand 22 is maintained at the lowest point. This gesture would generate a signal intensity profile which can be represented by a graph containing two substantially overlapped upward slopes, each followed by a flat portion, as shown in FIG. 14b.

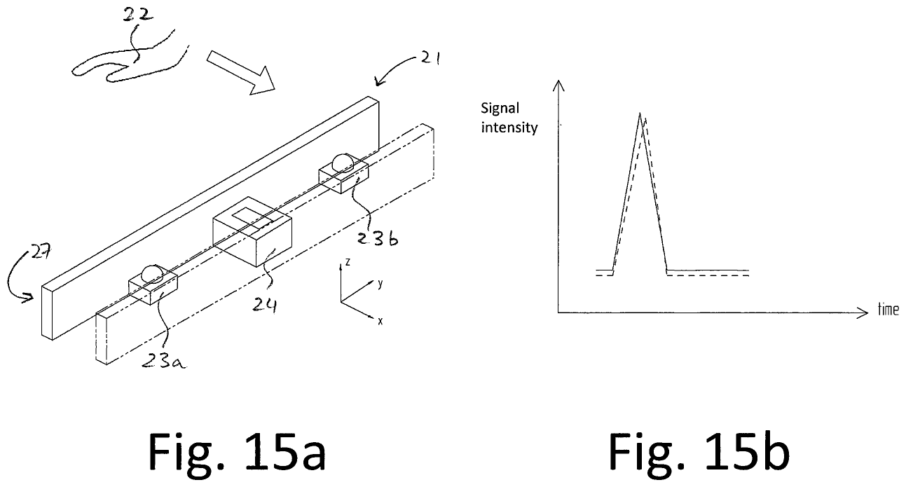

FIG. 15a illustrates a lateral swiping gesture, which requires the user's hand to swipe along the X-axis. To perform a lateral swiping gesture, the user's hand is initially is placed outside of the field of detection 26, followed by swiping across the field of detection 26 laterally across the adjusting means 27. According to FIG. 15b, as the user's hand moves across the adjusting means 27, the hand induces a rapid change of infrared intensity as it crosses into and out of the field of detection 26 which is narrowed. The narrowed field of detection 26 significantly reduces the rise time or fall time of the infrared signal, generating a signal intensity profile which can be represented by a line graph containing two steep and substantially overlapped upward-downward slopes, i.e., two overlapped spikes, as shown in FIG. 15b.

By incorporating the adjusting means 27, a lateral swiping gesture along the X-axis can now be easily distinguished from other gestures as discussed, in particular, the tapping gesture previously described and illustrated in FIG. 5a and FIG. 5b.

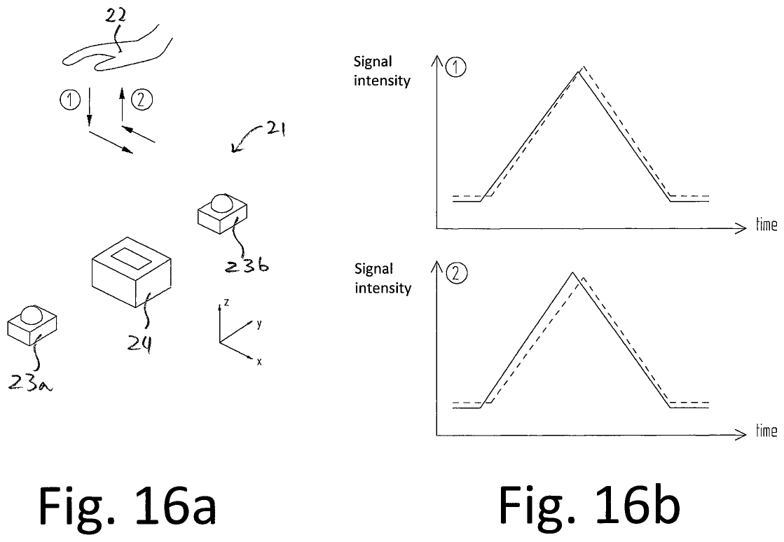

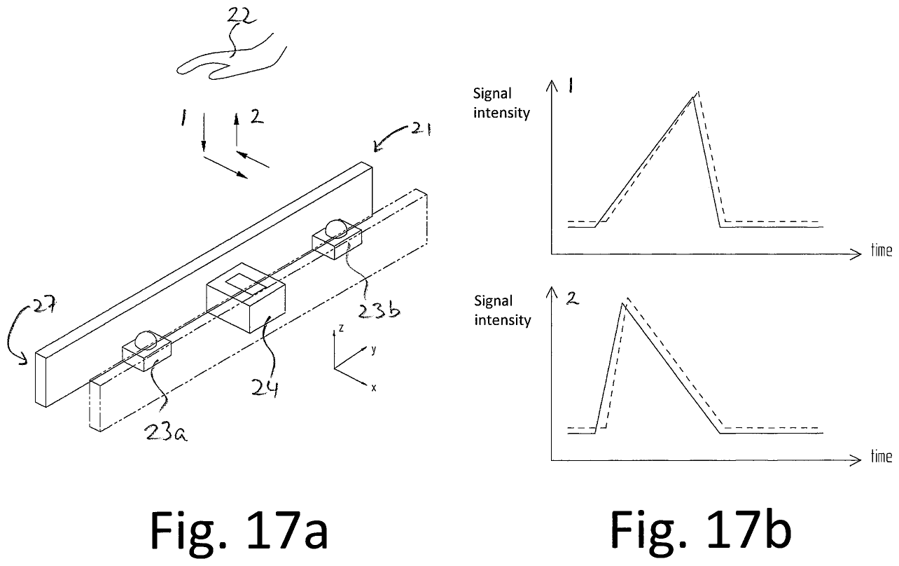

FIGS. 16a-17c illustrate a comparison of the signal intensity profiles resulted from two different gestures performed over the gesture detecting apparatus 21 with and without the adjusting means 27.

As shown in the FIG. 16a, the first gesture (1) is a compound gesture comprises a vertical descending gesture followed by a lateral swiping gesture. Essentially, the second gesture (2) is the reverse of the first gesture, comprising a lateral swiping gesture in an opposite direction, followed by a vertical ascending gesture. In this case, no guide is used on the gesture detecting apparatus.

According to FIG. 16b, each of the two gestures produces a signal intensity profile containing two substantially overlapping upward-downward slopes, indicating that the rates of rise and fall of signal intensity are more or less equal. In particular, the two signal intensity profiles would have a high resemblance of each other, making the first gesture (1) and the second gesture (2) difficult to be recognized and distinguished by the algorithm.

Referring to FIG. 17a, the same two gestures are performed over the gesture detecting apparatus provided with the adjusting means 27 incorporated as shown. According to the first line graph in FIG. 17b, the first gesture (1) initially produces a signal intensity profile having an upward slope generated by the user's hand 22 vertically descends towards the receiver, then followed by an abrupt downward slope caused by the user's hand 22 engages a lateral swiping gesture which moves away from the field of detection 26 along the X-axis. The signal intensity profile resulting from the first gesture (1) indicates that signal rise time is longer than the signal fall time.

Referring to the second line graph in FIG. 17b, the graph illustrates that the signal pattern resulted from the second gesture (2) would initially have an abrupt upward slope caused by the user's hand 22 moves into the field of detection 26 along the X-axis by engaging a lateral swipe gesture, followed by a downward slope as the user's hand 22 ascends upward from the infrared receiver 24. Accordingly, the second gesture (2) would produce a signal intensity profile substantially different (i.e., laterally inverted) from that of the first gesture (1). The signal intensity profile resulting from the second gesture (2) indicates that signal rise time is shorter than the signal fall time. Accordingly, such a difference between the two signal intensity profiles would make the two gestures recognizable and distinguishable by the algorithm.

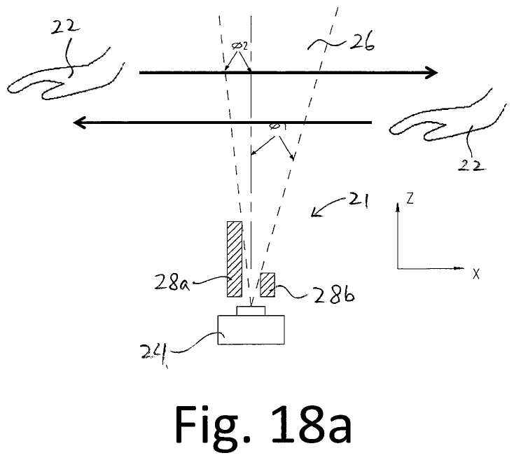

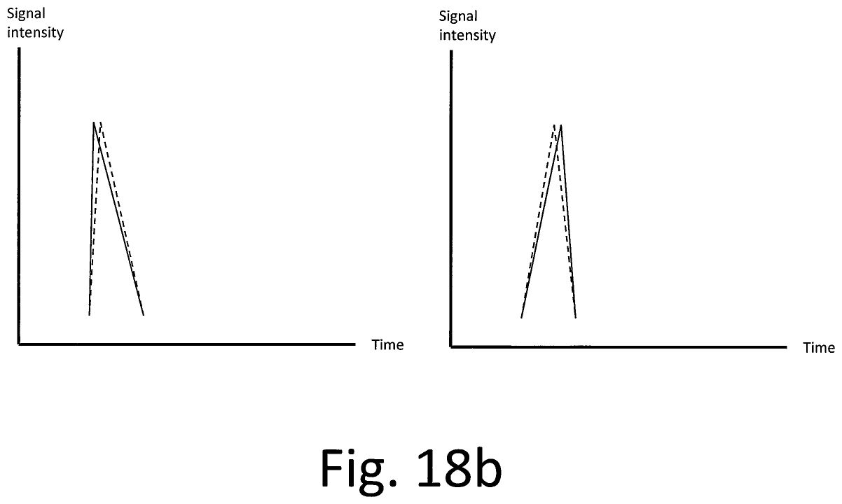

Furthermore, FIG. 18a illustrates an example of the adjusting means 27 which comprises walls 28a 28b having uneven heights. Specifically, one of the walls 28a is configured to be taller than the other wall 28b, causing an uneven or asymmetrical field of detection 26. This allows lateral swiping gestures performed in two opposing directions along the X-axis distinguishable, which their signal intensity profiles can be represented by the two distinctive line graphs in FIG. 18b.

In addition to the foregoing, different and more complex gestures can be defined by combining the aforementioned basic gestures, such as but not limiting to, longitudinal swiping, lateral swiping, vertical ascending and descending, tapping and hold. Each of the defined gestures can be associated with a command for executing a specific function in an event that one of the predefined gestures is performed by the user and successfully recognized by the gesture detecting apparatus.

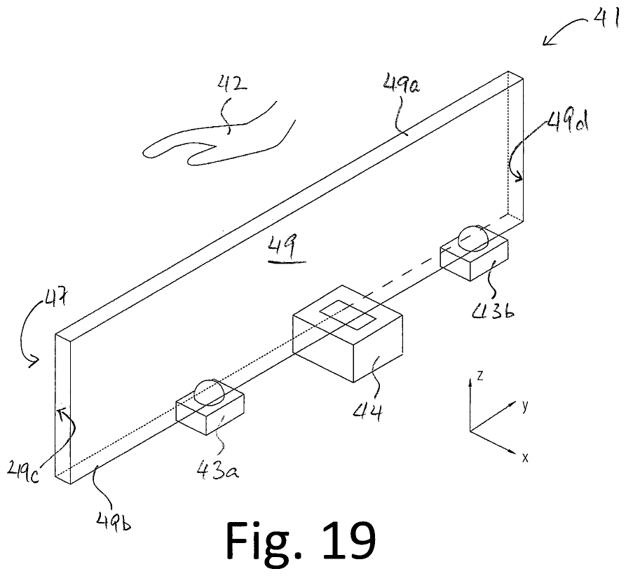

FIG. 19 shows another embodiment of gesture detecting apparatus 41 according to the present invention, having an adjusting means 47 comprising a light guide 49. The light guide 49 may be provided above the infrared emitters 43a, 43b and infrared receiver 44, as illustrated. Specifically, the light guide 49 may be an elongated lens made of a translucent material such as acrylic glass, i.e., polymethyl methacrylate (PMMA), situating above the infrared emitters 43a, 43b and the infrared receiver 44. The shape of the light guide 49 may be rectangular and have two laterally opposing principle sides. Advantageously, the light guide 49 may be mounted immediately above the infrared emitters 43a, 43b and the infrared receiver 44 for maximizing efficiency of reception. The light guide 49 has translucent top surface 49a and bottom surface 49b, and preferably non-reflective inner side surfaces 49c, 49d for suppressing internal reflection. When infrared rays pass through the light guide 49 from the bottom surface 49b, the light guide 49 would cause a certain degree of diffractions of the infrared rays.

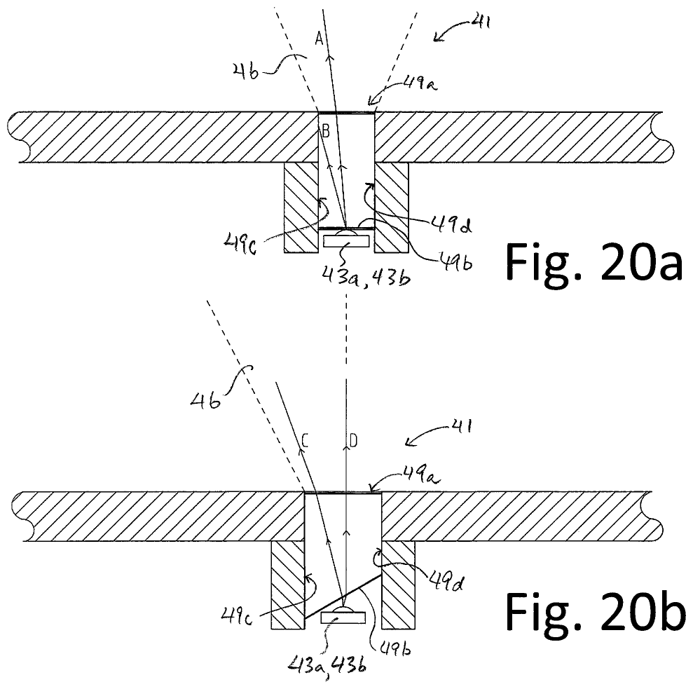

According to FIG. 20a, when incident infrared rays A and B emitted by the infrared emitters 43a, 43b, having different entry angles, enter the light guide 49 from the bottom surface 49b, within the light guide 49, rays A and B would be slightly diffracted as shown. Specifically, incident ray B enters the light guide 49 at an angle that interferes with one of one of the non-reflective inner sides 49c. As a result, incident infrared ray B cannot penetrate the light guide 49. As such, incident infrared rays exceeding a certain entry angle are unable to pass through the light guide 49, resulting in a controlled or restricted field of detection 46.

Alternatively, as illustrated in FIG. 20b, the field of detection 46 may be altered to bias to one side, for example, the left side. This creates an asymmetrical field of detection 46 similar to that as illustrated in FIG. 18a. As shown in the figure, the bottom surface 59b of the light guide 49 may be configured as an angled surface, resulting in an overall trapezoidal shape lens.

Incident infrared ray C enters the light guide 49 at the bottom surface 49b at certain entry angle. Altered by the effect of diffraction caused within the light guide 49, the exit angle of the resulted infrared ray C would have been further shifted with respect to the entry angle. The effect of diffraction causes the field of detection 56 skewed to the left side, resulting in an asymmetrical field of detection as shown. Likewise, incident infrared rays exceeding a certain entry angle would interfere with either of the inner non-reflective sides 49c, 49d, and are therefore absorbed and unable to exit the light guide 49.

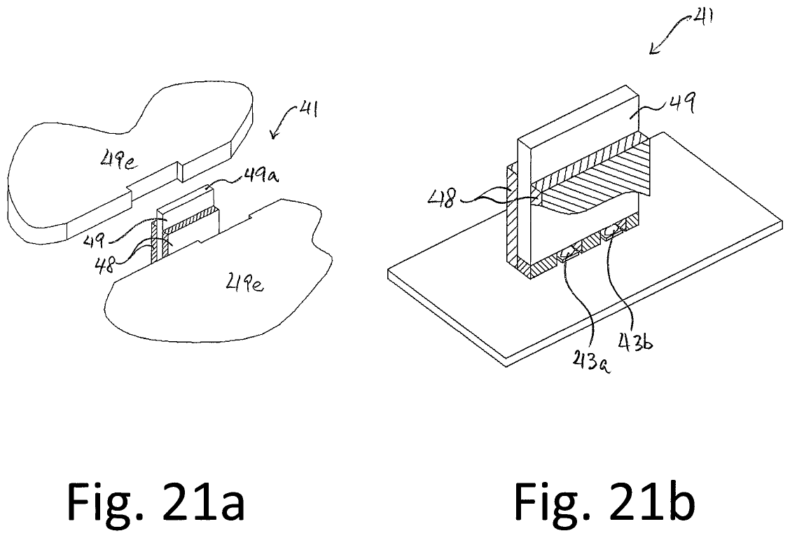

As shown in FIG. 21a, the light guide 49 may be configured in such a way that it provides the gesture detecting apparatus 41 an obscuring functionality. Preferably, the top surface 49a of the light guide 49 sits flush with the periphery surfaces 49e of the electronic appliance, providing a clean, subtle appearance while keeping the gesture detecting apparatus 41 protected. Further, opaque walls 48 may be provided outside the light guide 49. The addition of the opaque walls 48 effectively blocks out any infrared signals from entering the light guide 49 from the principle sides, reducing noise signals thus enhancing the accuracy of gesture detection. According to FIG. 21b which shows a cut-way view of the gesture detecting apparatus 41, the light guide 49 is preferably positioned immediately above the infrared emitters 43a, 43b and the infrared receiver 44.

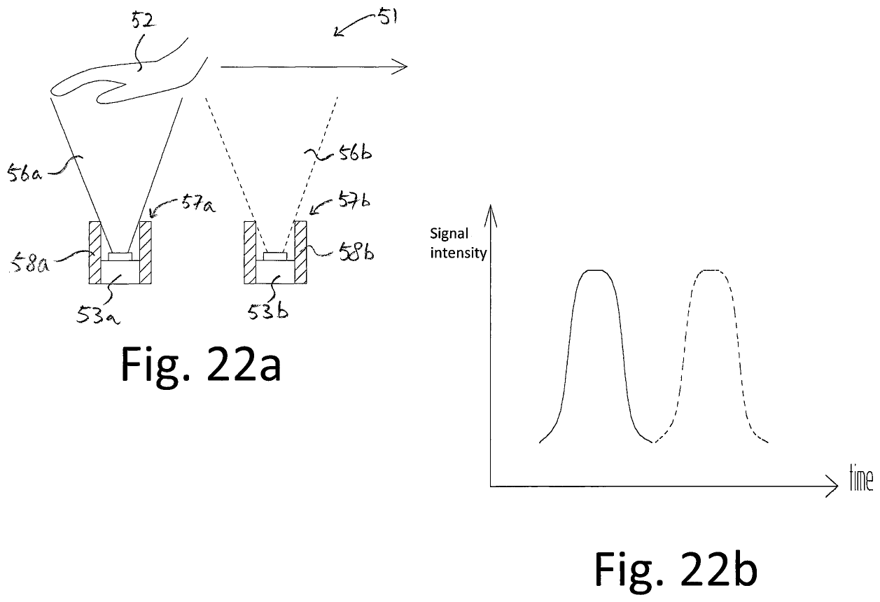

According to a further embodiment of the present invention, the gesture detecting apparatus 51 may include more than one set of infrared emitter and receiver, i.e., two sets of transceiver 53a, 53b. As shown in FIG. 22a, the gesture detecting apparatus 51 is configured to use the two transceiver sets to generate two fields of detection 56a, 56b. Adjusting means 57a, 57b, i.e., two sets of parallel walls 68a, 68b, may be provided for each transceiver set 53a, 53b to restrict the fields of detection 56a, 56b into two narrowed non-overlapping fields 56a, 56b. Such arrangement allows the algorithm to identify two signal intensity profiles which are distinct, as represented in the line graph shown in FIG. 22b. By identifying the sequence and the time delay between the two signal intensity profiles, directional swiping gestures can be effectively recognized and distinguished by the algorithm.

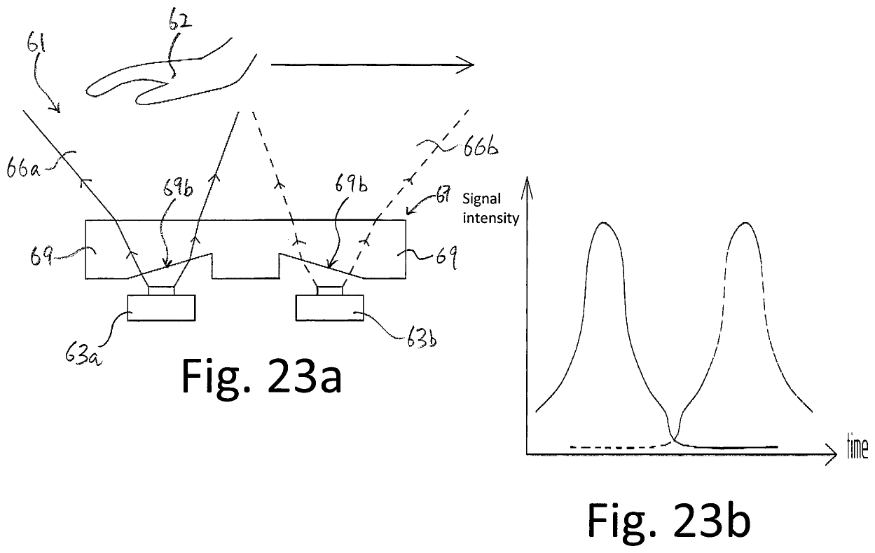

In FIG. 23a, a light guide 69 may be provided above the two transceiver sets 63a, 63b, and functions as an adjusting means 67. The two transceiver sets 63a, 63b are spaced apart from each other by a distance. In particular, the bottom surfaces 69b of light guide 69 which interfaces each of the transceiver sets 63a, 63b may be angled, which causes the fields of detection 66a, 76b skewed away from each other. The two fields of detection 66a, 66b are now biased outwardly and thus do not overlap. Accordingly, when a lateral swiping gesture is performed, the gesture would generate two distinct signal intensity profiles which can be represented by the line graph shown in FIG. 23b. Since the two signal intensity profiles are distinct, the accuracy of recognition by the algorithm may be enhanced. Advantageously, the use of such light guide 69 as described can minimize the required distance between the two transceiver sets 63a, 63b without causing signal cross-talking, thus the overall size of the gesture detecting apparatus 61 can be minimized.

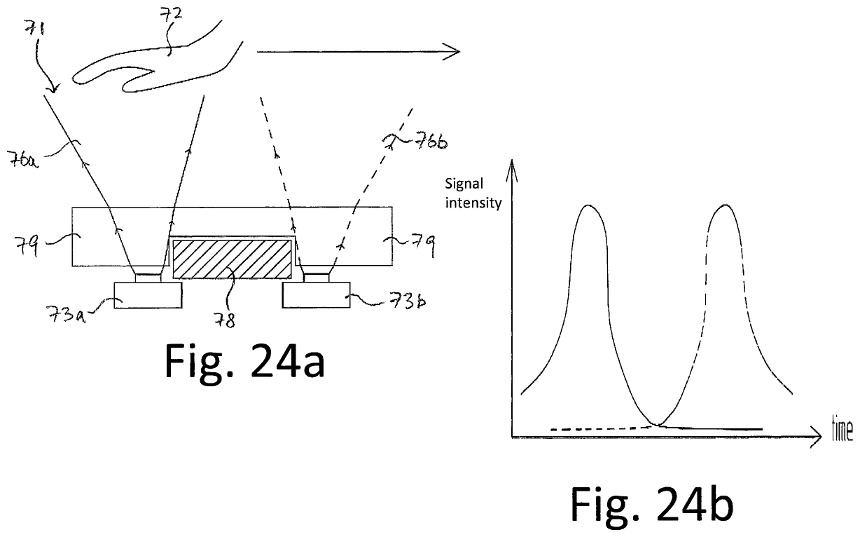

Alternatively, a blockage 78 may be positioned in between the two transceiver sets 73a, 73b in the manner as shown in FIG. 24a. The blockage is positioned in such a way that narrows the fields of detection 76a, 76b so that they do not overlap. Accordingly, performing a right lateral swiping gesture over the gesture detecting apparatus 81 would produce two distinct and non-overlapping signal intensity profiles represented by the line graph in FIG. 24b, which are substantially similar to those as illustrated in FIG. 23b.

According to the present invention, the infrared emitters, the receivers and the adjusting means may be all provided on a printed circuit board, or integrated into a single self-contained package. This further reduces the footprint and space requirements of the gesture detecting apparatus and improves its usability in electric powered device of various sizes.

The gesture detecting apparatus according to the present invention may be implemented to an electric fan for controlling various operation modes of the fan, such as switching on, switching off, and changing the fan speeds. For example, the electric fan can be switched on by performing a hold gesture which requires placing a hand in the field of detection and maintaining its position for two seconds. Further, the electric fan can be switched off by performing a double tapping gesture. As a further example, the fan speed may be adjusted by performing a left swiping gesture or a right swiping gesture, which triggers the control module to increase or decrease the fan speed.

Although the foregoing has been described in details by way of illustrations and exemplary embodiments for the purpose of clarity and understanding, it would be recognized that the above described invention may be embodied in numerous other specific variations and embodiments without departing from the spirit or the essential characteristics of the present invention. While changes and modifications may be practiced, it is understood that the present invention is not to be limited by the foregoing details, but rather is to be defined by the scope of the appended claims.

1. An apparatus for detecting and recognizing a gesture provided by an object, comprising:
an infrared emitter for emitting infrared signals to be at least partially reflected by the object;
an infrared detector for detecting intensity of the infrared signals reflected by the object moving along an axis, said infrared emitter and said infrared detector generating a field of detection;
a processor associated with the infrared detector for quantizing the intensity of the infrared signals within a measurement cycle into a signal intensity profile, said processor being adapted to determine, by using an algorithm, whether the signal intensity profile conforms to a predetermined gesture profile associated with a specific gesture, then to execute a command associated with the predetermined gesture profile if the signal intensity profile conforms to the predetermined gesture profile, and
adjusting means extending parallel to a distance between said infrared emitter and said infrared detector, configured to restrict the field of detection such that the object moving along a first axis, parallel to said adjusting means, generates a first signal intensity profile distinguishable from a second signal intensity profile resulting from the object moving along a second axis, perpendicular to the first axis, within the field of detection.

2. The apparatus according to claim 1, wherein the field of detection is truncated, along at least one of the first axis and the second axis, by said adjusting means.

3. The apparatus according to claim 1, wherein the field of detection is asymmetrical along the second axis.

4. The apparatus according to claim 1, wherein said adjusting means is configured to further alter the field of detection such that the object moving along the second axis in a first direction generates a signal intensity profile distinguishable from a signal intensity profile resulting from the object moving along the second axis in a second direction opposite to the first direction.

5. the apparatus according to claim 1, wherein
said adjusting means comprises a pair of parallel walls, and
said infrared emitter and said infrared detector are positioned between said parallel walls.

6. The apparatus according to claim 5, wherein said parallel walls have different heights.

7. The apparatus according to claim 1, wherein
said adjusting means comprises a light guide positioned above said infrared emitter and said infrared detector, and
said light guide comprises at least one pair of opposing non-reflective principal sides.

8. The apparatus according to claim 7, wherein said light guide has a surface facing said infrared emitter or said infrared detector and angled such that the field of detection is skewed to one side.

9. The apparatus according to claim 7, wherein said light guide is positioned immediately above said infrared emitter and infrared detector.

10. The apparatus according to claim 1, wherein said infrared emitter and said infrared detector are a transceiver.

11. The apparatus according to claim 1, further comprising a blockage isolating said infrared detector within said adjusting means for minimizing cross talking between said infrared emitter and said infrared detector.

12. The apparatus according to claim 11, wherein said blockage has a lower height than said adjusting means.

13. An apparatus for detecting and recognizing a gesture provided by an object, comprising:
infrared emitters, comprising at least a first infrared emitter and a second infrared emitter, for emitting infrared signals to be at least partially reflected by the object;
an infrared detector, positioned in between said first infrared emitter and said second infrared emitter, for detecting intensity of the infrared signals reflected by the object moving along an axis, said infrared emitters and said infrared detector generating a field of detection;
a processor for quantizing the intensity of the infrared signals within a measurement cycle into a signal intensity profile, said processor being adapted to determine, by using an algorithm, whether the signal intensity profile conforms to a predetermined gesture profile associated with a specific gesture, then to execute a command associated with the predetermined gesture profile if the signal intensity profile conforms to the predetermined gesture profile, and
adjusting means extending parallel to a distance between said infrared emitters, configured to restrict the field of detection such that the object moving along a first axis, parallel to said adjusting means, a second axis, perpendicular to said first axis, or a third axis, perpendicular to the first axis and the second axis, thereby causing generation of respective signal intensity profiles distinguishable from each other.

14. The apparatus according to claim 13, wherein the field of detection is truncated, along at least one of the first axis and the second axis, by said adjusting means.

15. The apparatus according to claim 13, wherein the field of detection is asymmetrical along the second axis.

16. The apparatus according to claim 13, wherein said adjusting means is further configured to restrict the field of detection such that said the object moving along the second axis in a first direction generates a signal intensity profile distinguishable from a signal intensity profile resulting from the object moving along the second axis in a second direction.

17. The apparatus according to claim 13, wherein
said adjusting means comprises a pair of parallel walls, and
said first infrared emitter and said infrared detector are positioned between said parallel walls.

18. The apparatus according to claim 17, wherein said parallel walls have different heights.

19. The apparatus according to claim 13, wherein
said adjusting means comprises a light guide positioned above said infrared emitters and said infrared detector, and
said light guide comprises at least one pair of opposing non-reflective principal sides.

20. The apparatus according to claim 19, wherein said light guide includes a surface facing said infrared emitters or said infrared detector and angled such that the field of detection is skewed to one side.

21. The apparatus according to claim 19, wherein said light guide is positioned immediately above said infrared emitters and infrared detector.

22. The apparatus according to claim 13, further comprising a blockage isolating said infrared detector within said adjusting means for minimizing cross talking between said infrared emitter and said infrared detector.

23. The apparatus according to claim 22, wherein said blockage has a lower height than said adjusting means.
